(19) United States
(12) Patent Application Publication
(10) Pub. No.: US 2013/0339417 A1
(43) Pub. Date: Dec. 19, 2013

(54) RESIDUE-BASED EXPONENT FLOW CHECKING

(71) Applicants: Juergen Haess, Schoenaich (DE); Michael K. Kroener, Ehningen (DE); Silvia M. Mueller, Altdorf (DE); Kerstin Schelm, Stuttgart (DE)

(72) Inventors: Juergen Haess, Schoenaich (DE); Michael K. Kroener, Ehningen (DE); Silvia M. Mueller, Altdorf (DE); Kerstin Schelm, Stuttgart (DE)

(73) Assignee: INTERNATIONAL BUSINESS MACHINES CORPORATION, Austin, TX (US)

(21) Appl. No.: 13/517,839

(22) Filed: Jun. 14, 2012

(51) Int. Cl. G06F 7/38

(52) U.S. Cl. 708/512

(57) ABSTRACT

A technique for checking an exponent calculation for an execution unit that supports floating point operations includes generating, using a residue prediction circuit, a predicted exponent residue for a result exponent of a floating point operation. The technique also includes generating, using an exponent calculation circuit, the result exponent for the floating point operation and generating, using the residue prediction circuit, a result exponent residue for the result exponent. Finally, the technique includes comparing the predicted exponent residue to the result exponent residue to determine whether the result exponent generated by the exponent calculation circuit is correct and, if not, signaling an error.

### BACKGROUND

1. Field

This disclosure relates generally to error detection for an execution unit of a processor and, more particularly, to residue-based error detection of exponents for a processor execution unit that supports floating point operations.

2. Related Art

Today, it is common for processors to be designed to detect errors. For example, one known processor design has implemented two identical processor pipelines. In this processor design, processor errors are detected by comparing results of the two identical processor pipelines. While duplicating processor pipelines improves error detection, duplicating processor pipelines is relatively expensive in terms of integrated circuit (chip) area and chip power consumption. A less expensive technique (e.g., in terms of chip area and chip power consumption) for detecting errors in an execution unit of a processor has employed residue checking.

Residue-based error detection (or residue checking) has been widely employed in various applications. For example, U.S. Pat. No. 3,816,728 (hereinafter “the '728 patent”) discloses a modulo 9 residue checking circuit for detecting errors in decimal addition operations. As another example, U.S. Pat. No. 4,926,374 (hereinafter “the '374 patent”) discloses a residue checking apparatus that is configured to detect errors in addition, subtraction, multiplication, division, and square root operations. As yet another example, U.S. Pat. No. 7,555,692 (hereinafter “the '692 patent”) discloses logic for computing residues for full-sized data and reduce-sized data. Typically, an operand provided to an input of residue generator has not included all input bits, as floating-point data includes a mantissa or significand (that has typically been handled by the residue generator) and an exponent that has been extracted and handled separately. However, U.S. Pat. No. 7,769,795 (hereinafter “the '795 patent”) discloses checking floating-point data as a whole (i.e., mantissa, exponent, and sign) using a residue-based approach.

### SUMMARY

According to one aspect of the present disclosure, a technique for checking an exponent calculation for an execution unit that supports floating point operations includes generating, using an exponent calculation circuit, a result exponent for a floating point operation. The technique also includes generating, using a residue prediction circuit, a predicted exponent residue for the result exponent and generating, using the residue prediction circuit, a result exponent residue for the result exponent. Finally, the technique includes comparing the predicted exponent residue to the result exponent residue to determine whether the result exponent generated by the exponent calculation circuit is correct and, if not, signaling an error.

### BRIEF DESCRIPTION OF THE DRAWINGS

The present invention is illustrated by way of example and is not intended to be limited by the accompanying figures, in which like references indicate similar elements. Elements in the figures are illustrated for simplicity and clarity and have not necessarily been drawn to scale.

FIG. 1 is a diagram illustrating an exemplary floating-point unit (FPU) of a processor that includes a residue generating circuit that has residue generators that employ split data (mantissa) residue generation trees.

FIG. 2 is a diagram illustrating a relevant portion of an exemplary residue generation tree for data (mantissas) provided to the residue generators of FIG. 1.

FIG. 3 is a diagram illustrating an exemplary residue checking data (mantissa) flow for the FPU of FIG. 1.

FIG. 4 is a diagram illustrating a conventional exponent checking unit for the FPU of FIG. 1.

FIG. 5 is a diagram illustrating an exemplary exponent residue checking flow for the FPU of FIG. 1, according to an embodiment of the present disclosure.

FIG. 6 is a diagram illustrating a number of exemplary expressions that provide constants that may need to be added to generate a result exponent.

FIG. 7 is a diagram illustrating a reduced number of expressions (as compared to the expressions in FIG. 6) that provide constants that may need to be added to generate a result exponent according to an embodiment of the present disclosure.

FIG. 8 is a table listing constants that may need to be added for different expression addends to generate a residue for a result exponent according to an embodiment of the present disclosure.

FIG. 9 is a diagram illustrating a number of exemplary expressions for different events (cases) that provide variables that may need to be subtracted to generate a result exponent.

FIG. 10 is a diagram illustrating simplified expressions (as compared to the expressions in FIG. 9) that provide variables that may need to be subtracted to generate a result exponent according to an embodiment of the present disclosure.

FIG. 11 is a table listing variables that may need to be subtracted for different events to generate a residue for a result exponent according to an embodiment of the present disclosure.

FIG. 12 is a flowchart of an exemplary exponent residue checking process for the exponent residue checking flow of FIG. 5.

FIG. 13 is a flow diagram of a design process used in semiconductor design, manufacture, and/or test.

### DETAILED DESCRIPTION

As will be appreciated by one of ordinary skill in the art, the present invention may be embodied as a method, system, device, or computer program product. Accordingly, the present invention may take the form of an embodiment including hardware, an embodiment including software (including firmware, resident software, microcode, etc.), or an embodiment combining software and hardware aspects that may all generally be referred to herein as a circuit, module, or system. The present invention may, for example, take the form of a computer program product on a computer-usable storage medium having computer-usable program code, e.g., in the form of one or more design files, embodied in the medium.

Any suitable computer-usable or computer-readable storage medium may be utilized. The computer-usable or computer-readable storage medium may be, for example, but is not limited to, an electronic, magnetic, optical, electromagnetic, infrared, or semiconductor system, apparatus, or device. More specific examples (a non-exhaustive list) of the computer-readable storage medium include: a portable computer diskette, a hard disk, a random access memory (RAM), a read-only memory (ROM), an erasable programmable read-only memory (EPROM) or flash memory, a portable compact disc read-only memory (CD-ROM), an optical storage device, or a magnetic storage device.

As used herein the term “coupled” includes a direct electrical connection between elements or blocks and an indirect electrical connection between elements or blocks achieved using one or more intervening elements or blocks. The term ‘residue checking’, as used herein, refers to the use of the mathematical residues of operands, results, and remainders to verify the result of a mathematical operation. As used herein, the term ‘residue’ refers to the remainder produced by modulo-N division of a number.

While the discussion herein focuses on a residue prediction circuit for a floating-point unit (FPU), it is contemplated that a residue prediction circuit configured according to the present disclosure has broad application to other type of execution units (e.g., vectorized execution units such as single-instruction multiple data (SIMD) execution units). While the discussion herein focuses on modulo 15 and modulo 3 residue generation trees for calculating residues for operand mantissas and operand exponents, respectively, it should be appreciated that other modulos may be utilized in a residue prediction circuit configured according to the present disclosure. While the discussion herein focuses on an operand register with thirty-two bits, it should be appreciated that the techniques disclosed herein are applicable to operand registers with more or less than thirty-two bits. Additionally, while the discussion herein focuses on short format operands with twelve bits, it should be appreciated that the techniques disclosed herein are applicable to short format operands with more or less than twelve bits (e.g., twenty-three bits). In addition, while the discussion herein focuses on long format operands with thirty-two bits, it should be appreciated that the techniques disclosed herein are applicable to long format operands with more or less than thirty-two bits (e.g., a floating point format that employs fifty-two bits).

According to various aspects of the present disclosure, a residue prediction circuit is disclosed that ensures that exponent calculations of various floating-point operations (e.g., addition, subtraction, multiplication, division, square root, and conversion) are correct. It should be appreciated that exponent flows are more difficult to check than data (mantissa) flows, as exponent flows have more special cases and exponent data may be changed in many ways that are difficult to predict and usually require more stages to check.

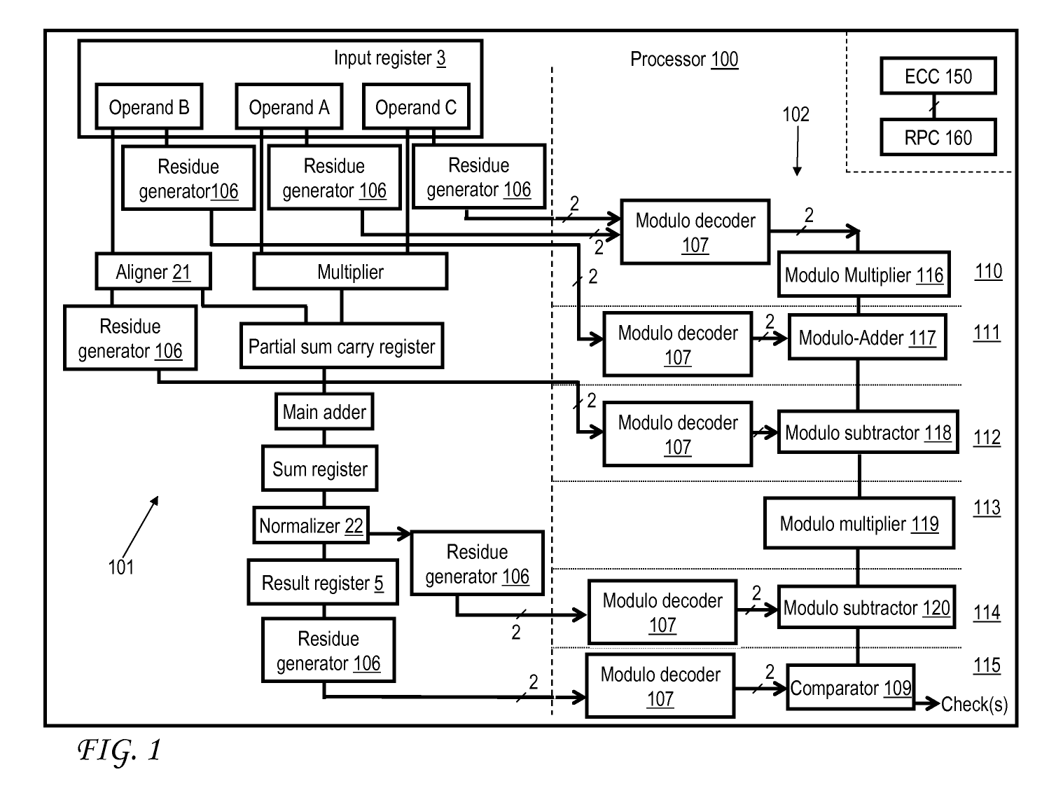

With reference to FIG. 1, a portion of an exemplary floating point unit (FPU) of a processor 100 is illustrated. Processor 100 includes an exponent calculating circuit (EXCC) 150 coupled to a residue prediction circuit (RPC) 160 that facilitates exponent residue checking according to the present disclosure. Residue checking for operand mantissas is performed within a mantissa residue checking flow 102, by performing the same operations on the residue as those performed on operand mantissas by the FPU, in parallel with data (mantissa) flow 101 within the FPU. Operands A, B and C (which include both mantissas and associated exponents) are provided by an input register 3 in data flow 101. Operands A, B and C may be long format operands or may each include multiple short format operands. In any event, mantissas for operands A, B and C are processed differently based on different functional elements, such as aligner 21 and normalizer 22, and a result is provided by a result register 5. Residues (for mantissas) are generated at illustrated positions within flow 101 by residue generators 106. Modulo decoders 107, which are coupled to residue generators 106, provide residue modulos for mantissas of operands A, B and C to different functional elements (i.e., modulo multiplier 116, modulo adder 117, modulo subtractor 118, modulo subtractor 120, and comparator 109) within mantissa residue checking flow 102.

In a first stage 110 of flow 102, the residue modulos of the mantissas of operands A and C are multiplied by modulo multiplier 116. In a second stage 111 of flow 102, the residue modulo from the mantissa of operand B is added to the product-residue modulo from stage 110 using modulo adder 117. In a third stage 112 of flow 102, the residue modulo of bits lost at aligner 21 is subtracted by modulo subtractor 118 from the sum of second stage 111. During the residue checking operation, residue corrections to the actual residue value corresponding to the manipulated data in flow 101 may be necessary. For example, a normalization shift correction may be necessary. As such, in a fourth stage 113 of checking flow 102, residue correction of the normalization shift is performed by modulo multiplier 119. Then, in a fifth stage 114 of flow 102, a subtraction of the bits lost at normalizer 22 is performed by modulo subtractor 120. Finally, in a sixth stage 115 of flow 102, a check operation is performed by comparator 109. That is, comparator 109 compares the result provided by modulo subtractor 120 with the residue modulo of the result provided by result register 5 of flow 101.

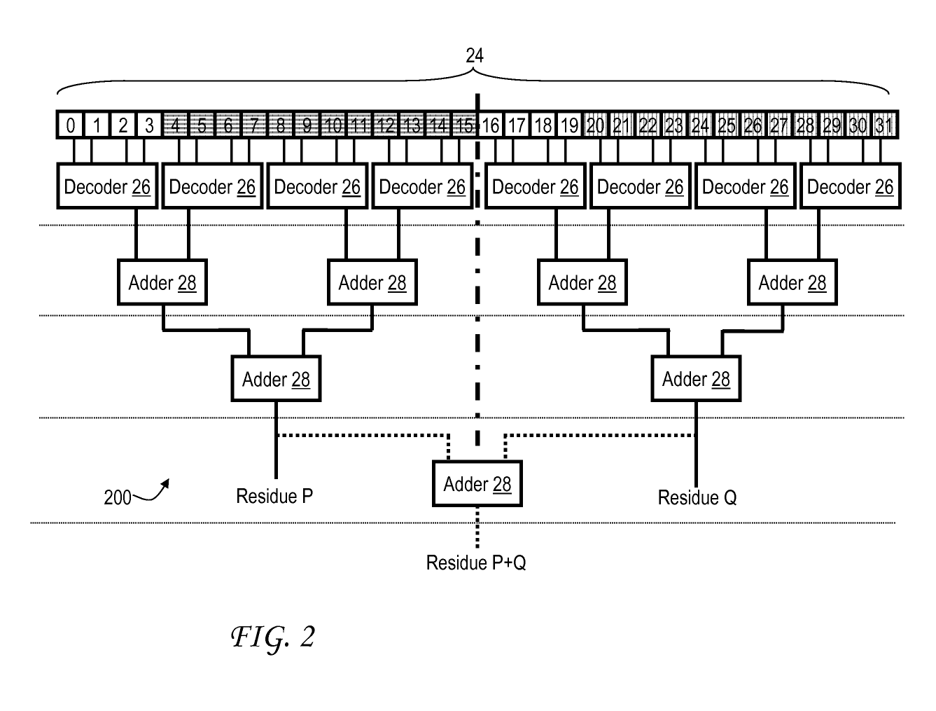

With reference to FIG. 2, an exemplary modulo 15 residue generation tree 200, that may be implemented in a residue generator 106 (see FIG. 1), is illustrated. According to one or more embodiments of the present disclosure, modulo 15 residue generation trees are implemented to provide residues for each of the mantissas of the operands A, B, and C. Operand register 24 may be configured to store thirty-two bits of a long format operand, starting with an MSB in the register labeled ‘0’ and ending with an LSB in the register labeled ‘31’. Operand register 24 may also be symmetrically divided and configured to store two short format operands (with an operand ‘P’ included in the registers labeled 0-15 and an operand ‘Q’ included in the registers labeled 16-31). As illustrated in FIG. 2, operands ‘P’ and ‘Q’ are right-aligned within their respective halves of operand register 24, operand ‘P’ is stored in the registers labeled 4-15, and operand ‘Q’ is stored in the registers labeled 20-31. Residue generation tree 200 of FIG. 2 includes a plurality of modulo 15 decoders 26 and a plurality of modulo adders (residue condensers) 28. Each decoder 26 is coupled to four adjacent register bits of operand register 24 (for receiving four parallel bits of numerical data) and each decoder 26 decodes the numerical data received from the respective register bits.

Decoders 26 transform coded signals into decoded signals that are modulo remainders. Modulo adders 28, positioned at different levels, receive the decoded numerical data from decoders 26. Adders 28 may, for example, be replaced with a series of decoders and multiplexers that perform residue condensing. Outputs of each adjacent pair of decoders 26 are coupled to inputs of a different adder 28 in a first condenser stage. Inputs of each adder 28 in a second condenser stage are coupled to respective outputs of two adders 28 in the first condenser stage. An output of each adder 28 in the second condenser stage may be configured to generate a different residue for a short format operand or may be coupled to respective inputs of an adder 28 in a third condenser stage. In this case, an output of an adder 28 in the third condenser stage is configured to generate a residue for a long format operand. In residue generation tree 200, an operand provided to register 24 may not use all of the input bits. In this case, register bits of an operand in operand register 24 that are not used may be filled with logical zeros (or other bits that do not affect the residue) by unillustrated control logic.

Right-aligning short format operands within their respective register sections of a dataflow (as shown in FIG. 2) is one approach for aligning short format operands within respective register sections without optimization. In general, there may be reasons to align short format operands within their respective register sections differently. For example, a left operand may be left-aligned to make use of existing full data width overflow detection of bit ‘0’. In general, symmetrically splitting an operand register into equal halves is the intuitive way of splitting an operand register for floating point operations. However, depending on the purpose for splitting an operand register, an asymmetrical split of the operand register may be desirable. For example, as single precision floating-point data of twenty-three bits does not correspond to one-half of double precision floating-point data of fifty-two bits, a split after bits ‘0’ through ‘22’ may be an appropriate way of splitting an operand register of fifty-two bits into two unequal sized sections for two short format operands.

As short format operands do not necessarily fill a section of an operand register, various criteria may be taken into consideration when determining how to position short format data in an operand register. For example, to make best use of existing logic that services an operand register for long format operands, short format operands may be aligned within sections of an operand register to facilitate maximum re-use of the existing logic (e.g., decoders, counters, and comparators). As one example, it may be advantageous to position short format operands asymmetrically within an operand register to pass middle bits of the operand register.

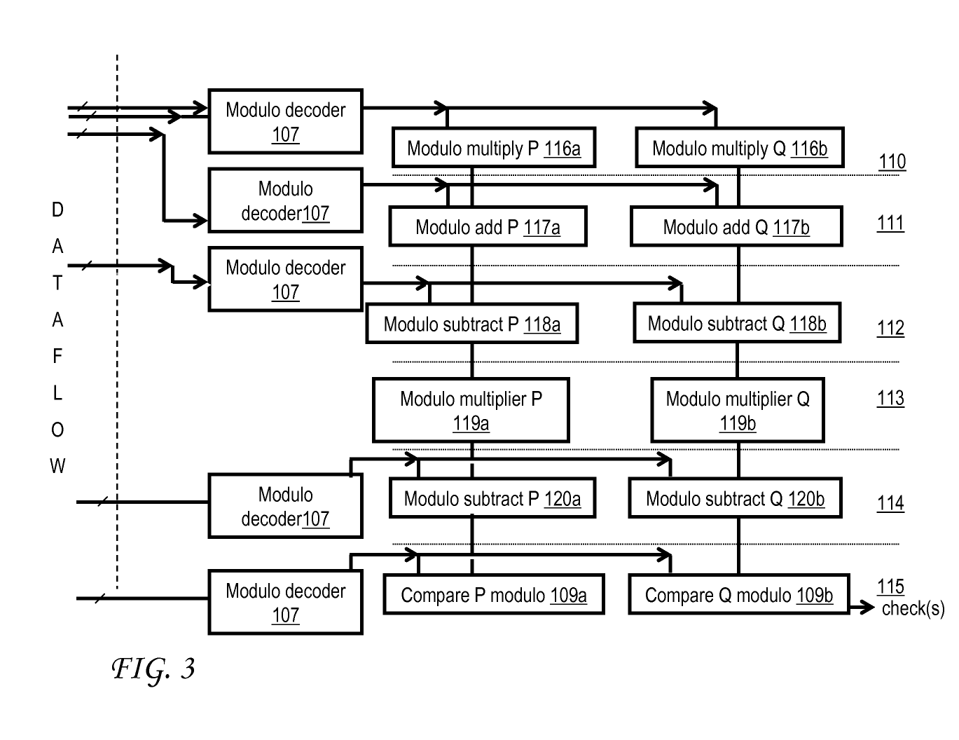

With reference to FIG. 3, flow 102 is illustrated in further detail. In first stage 110, the residue modulos (i.e., modulo P and modulo Q) of the mantissas of operands A and C are multiplied by modulo multipliers 116a and 116b. Next, in second stage 111, the residue modulo from the mantissa of operand B is added to the product-residue modulo from stage 110 using modulo adders 117a and 117b. Then, in third stage 112, the residue modulo of bits lost at aligner 21 is subtracted by modulo subtractors 118a and 118b from the sum of second stage 111. During the residue checking operation, residue corrections to the actual residue value corresponding to the manipulated data in flow 101 may be necessary. For example, a normalization shift may be necessary. As such, in a fourth stage 113, residue correction of the normalization shift is performed by modulo multipliers 119a and 119b. Then, in a fifth stage 114, a subtraction of the bits lost at normalizer 22 is performed by modulo subtractors 120a and 120b. Finally, in a sixth stage 115, a check operation is performed by comparators 109a and 109b. That is, comparators 109a and 109b compare the results provided by modulo subtractors 120a and 120b with the residue modulos of the result provided by result register 5 of flow 101. It should be appreciated that when the residue modules provided by result register 5 are the same as the results provided by modulo subtractors 120a and 120b, signals at the output of comparators 109a and 109b indicate a pass condition. On the other hand, when the residue modules provided by result register 5 are not the same as the results provided by modulo subtractors 120a and 120b, signals at the output of comparators 109a and 109b indicates a fail condition.

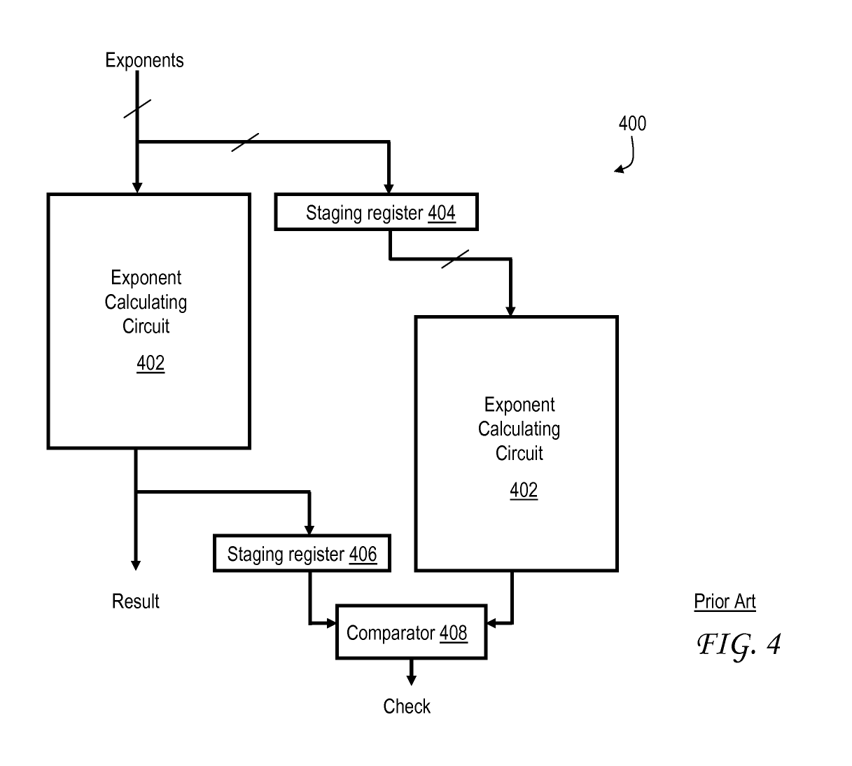

With reference to FIG. 4 an exemplary conventional exponent checking unit 400 for an FPU is illustrated. As previously noted, conventional processor checking apparatus have only checked data flow or have duplicated relatively expensive exponent logic, which is costly in terms of increased chip area, increased chip wiring, increased chip timing, and has required additional chip design effort. As is illustrated in FIG. 4, exponent calculating circuit 402 is duplicated to facilitate exponent checking. For example, exponent calculating circuit 402 may take the form of the circuitry illustrated in flow 101 of FIG. 1 without residue generators 106. Unfortunately, logic duplication for exponent checking requires additional conductors to staging registers 404 and 406, which act as buffers for timing-critical loads. Comparator 408 is utilized to verify that both exponent calculating circuits 402 provide the same result exponent.

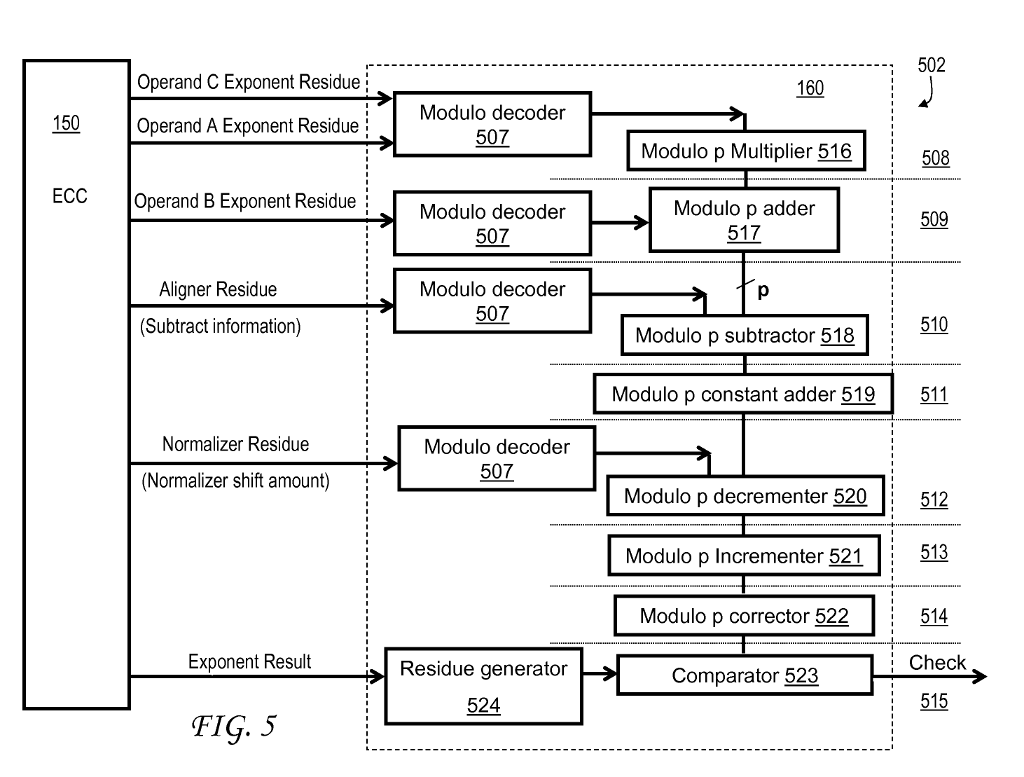

With reference to FIG. 5 an exemplary exponent residue checking flow 502 for the FPU of FIG. 1, according to an embodiment of the present disclosure, is illustrated. Flow 502, whose components form a residue checking circuit, receives various residue modulos from exponent calculating circuit (EXCC) 150. EXCC 150, which handles operand exponents, may be constructed in a similar manner as the circuitry illustrated in flow 101 of FIG. 1. Modulo decoders 507, which receive residues from residue generators (not illustrated in FIG. 5), provide modulo residues for exponents of operands A, B, and C to different functional elements (i.e., modulo p multiplier 516, modulo p adder 517, modulo p subtractor 518, and modulo p decrementer 520) within flow 502. In one or more embodiments, modulo 3 devices are employed for the exponents of operands A, B, and C. It should be appreciated that different modulos may be employed for the exponents. For example, modulos that are products of the primes 3, 5, 7, . . . may be employed in exponent flow checking according to the present disclosure.

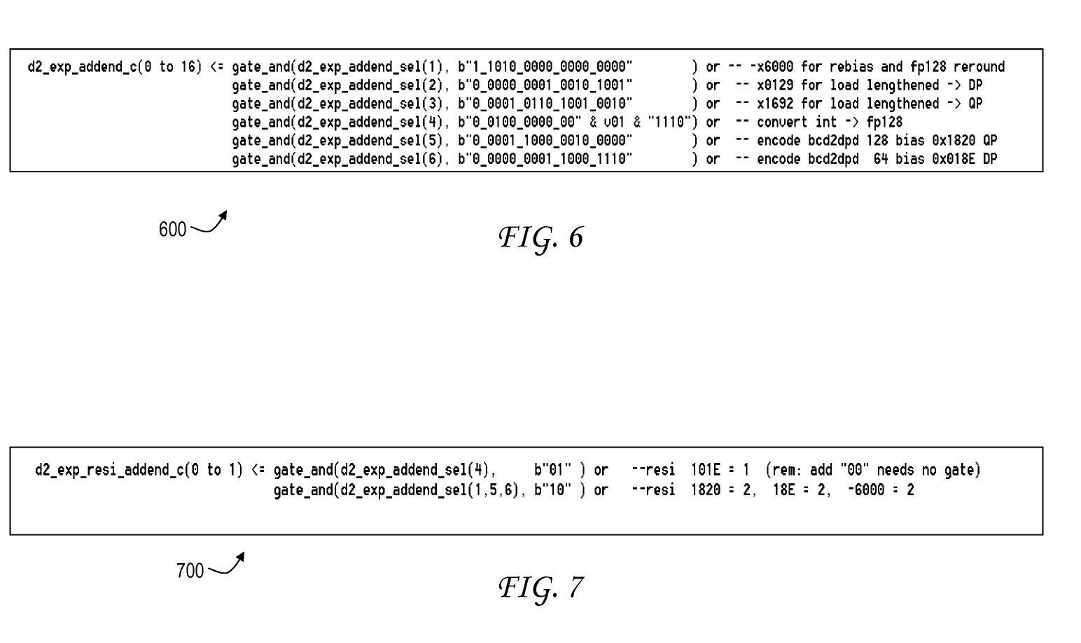

In a first stage 508 of flow 502, the residue modulos of the exponents for operands A and C are multiplied by modulo p multiplier 516. In a second stage 509 of flow 502, the residue modulo of the exponent for operand B is added to the product-residue modulo from stage 508 using modulo p adder 517. In a third stage 510 of flow 502, the residue modulo of subtract information (provided by an aligner) is subtracted by modulo p subtractor 518 from the sum of second stage 509. In a fourth stage 511 of flow 502, an appropriate constant (see FIGS. 6-8) is added by the modulo p constant adder 519 to a sum provided by third stage 510.

During the residue checking operation, residue corrections to the actual residue value corresponding to the manipulated data in flow 502 may be necessary. For example, a normalization shift correction may be necessary. As such, in a fifth stage 512 of checking flow 502, residue correction of the normalization shift is performed by modulo p decrementer 520 on the sum provided by fourth stage 511. Then, in a sixth stage 513 of flow 502, an increment by one is performed by modulo p incrementer 521 if required (to compensate for rounding errors in the exponent caused by fraction overflow). Next, in a seventh stage 514 of flow 502, a correction for overflow or underflow (caused by an intermediate result exponent that does not fit into a target format representation) is performed by modulo p corrector 522 if required. Finally, in an eighth stage 515 of flow 502, a check operation is performed by comparator 523. That is, comparator 523 compares the result provided by modulo p corrector 522 with the residue modulo of the result provided by residue generator 524, which generates the result residue of the exponent result delivered by EXCC 150. When the result provided by modulo p corrector 522 is the same as the residue modulo of the result provided by residue generator 524, a signal indicates a pass condition. On the other hand, when the result provided by modulo p corrector 522 is not the same as the residue modulo of the result provided by residue generator 524, a signal indicates a fail condition. As noted above, EXCC 150 may be constructed in a manner similar to the circuitry illustrated in data flow 101 (with residue generator 106 at the output of result register 5 being omitted, as residue generator 524 is implemented to generate the result residue of the exponent result).

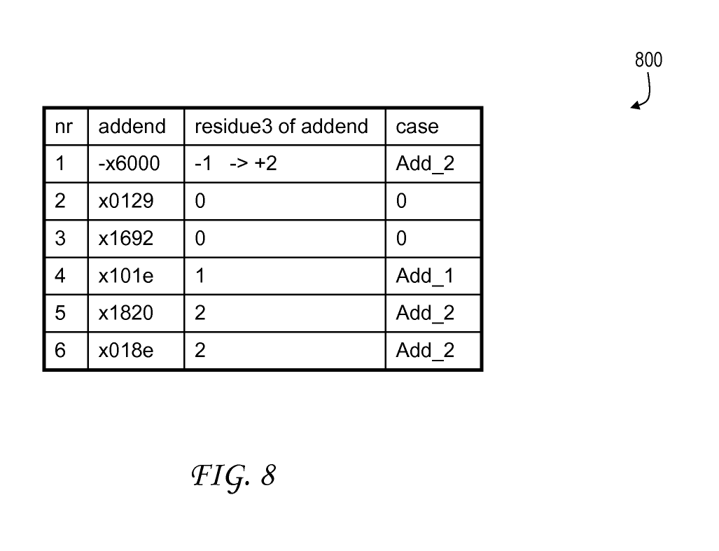

With reference to FIG. 6, a number of different expressions 600 are illustrated that provide instruction dependent exponent constants that may need to be added to generate a proper result exponent. For example, during exponent flow checking in fourth stage 511 of flow 502, various different residue constants, that correspond to the exponent constants, may need to be added. According to aspects of the present disclosure, expressions 600 are reduced to their residue values and combined to only a few groups 700, as is illustrated in FIG. 7. For example, for modulo 3 residues only two groups (i.e., add_{—}1 and add_{—}2) are required for constants that are to be added to the actual residue, as is illustrated in table 800 of FIG. 8.

With reference to table 800 of FIG. 8, addends with hexadecimal values of ‘−6000’ (binary value of −‘0110 0000 0000 0000’), ‘1820’ (binary value of ‘0001 1000 0010 0000’), and ‘018e’ (binary value of ‘0000 0001 1000 1110’) require a constant of two to be added to an intermediate residue, an addend with a hexadecimal value of ‘101e’ (binary value of ‘0001 0000 0001 1110’) requires a constant of one to be added to the intermediate residue, and addends with hexadecimal values of ‘0129’ (binary value of ‘0000 0001 0010 1001’) and ‘1692’ (binary value of ‘0001 0110 1001 0010’) do not require any constant to be added to the intermediate residue. It should be appreciated that a select signal that is used to select an exponent constant within EXCC 150 may also be used to select a corresponding residue constant.

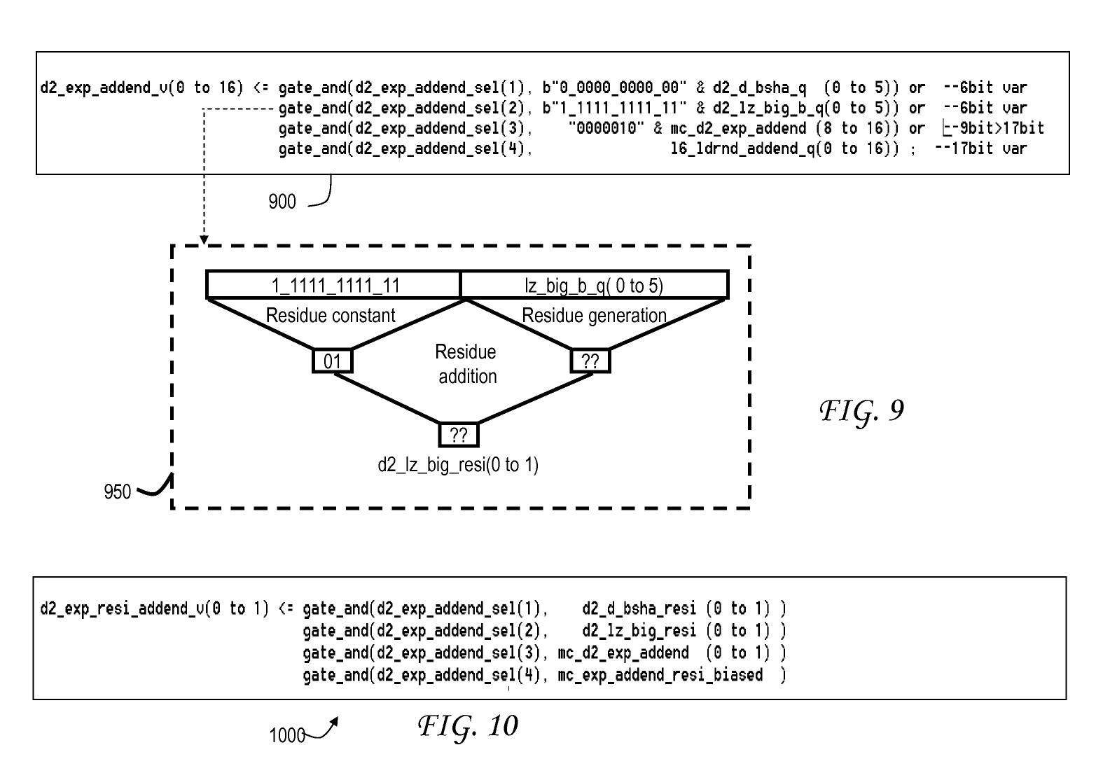

With reference to FIG. 9, a number of different expressions 900 are illustrated that have different variables that may need to be subtracted to generate a proper result exponent for different events. For example, during exponent flow checking in third stage 510 and fifth stage 512 of flow 502, various different variables may need to be subtracted to account for different exponent adjustments and different leading zero amounts, respectively. According to aspects of the present disclosure, a variable part is kept as small as possible to avoid full-width (e.g., 16-bit) residue generation. For example, d_bsha_q and lz_big_b_q may be limited to six bit residue generation as is further illustrated in expression 950 of FIG. 9. With reference to FIG. 10, simplified expressions (as compared to the expressions in FIG. 9) provide variables that may need to be subtracted to generate a result exponent.

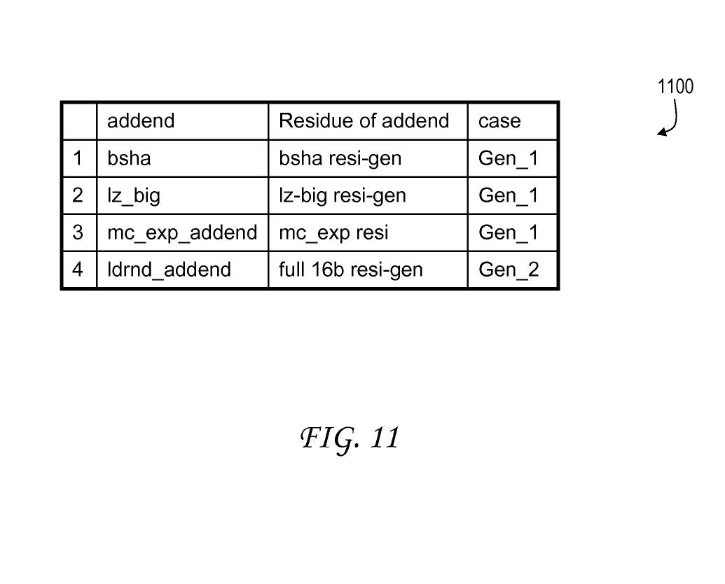

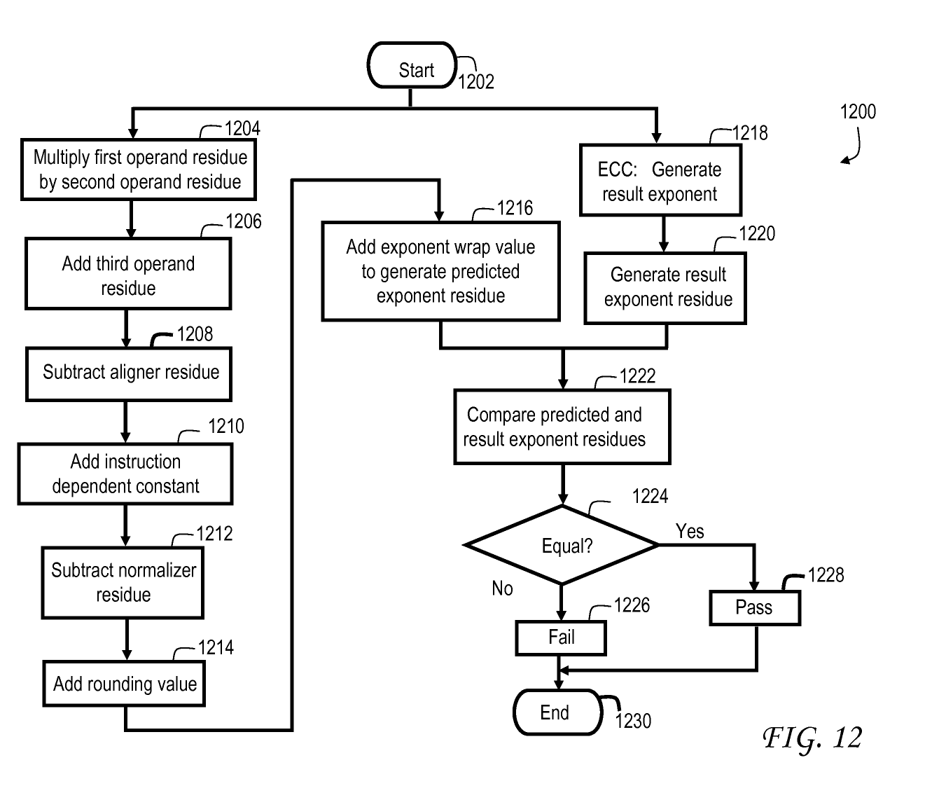

With reference to table 1100 of FIG. 11, addends with ‘bsha’ (i.e., a shift amount for operand B to accommodate proper number alignment due to different operand exponents), ‘lz_big’ (i.e., the number of leading zeroes of the bigger operand), and ‘mc_exp_addend’ (i.e., an additional constant that adjusts for special instructions) events (i.e., Gen_{—}1 cases) can be limited to only a few bits (e.g., six bits) for residue calculation, whereas addends with ‘ldrnd_addend’ (i.e., an exponent addend for a load rounded instruction) events (e.g., Gen_{—}2 cases) require a whole exponent width (e.g., 16-bit) residue calculation. According to various aspects of the present disclosure, shift amounts and/or leading zero counts for multiple variable addends may be reduced to necessary bits and combined into a few cases to reduce the complexity of calculating exponent residues.

With reference to FIGS. 5 and 12, a flowchart of an exemplary process 1200, implemented within a residue prediction circuit (RPC) 160 (that includes residue checking circuitry of flow 502 of FIG. 5 and residue generators provided by EXCC 150, as well as residue generator 524) of processor 100, is illustrated. The process 1200 performs exponent checking for a floating point operation (e.g., Result=Normalization((A*C)+/−B)). In block 1202 process 1200 is initiated, at which point blocks 1204-1216 and blocks 1218 and 1220 are implemented in parallel. In block 1204, modulo p multiplier 516 of RPC 160 multiplies a first operand exponent residue for a first operand exponent (i.e., an exponent of Operand C) by a second operand exponent residue for a second operand exponent (i.e., an exponent of Operand A) to generate a first intermediate exponent residue. Next, in block 1206, a third operand exponent residue for a third operand exponent (i.e., an exponent of Operand B) is added, by modulo p adder 517 of RPC 160, to the first intermediate exponent residue to generate a second intermediate exponent residue.

Then, in block 1208, an aligner residue correction associated with the third operand exponent is subtracted, by modulo p subtractor 518 of RPC 160, from the second intermediate exponent residue to generate a third intermediate exponent residue. For example, the third intermediate exponent residue may be determined by: selecting a subrange of variable bits for generation of an aligner residue for the third operand exponent based on an associated event; generating the aligner residue based on the selected subrange of variable bits and a residue constant that is based on constant bits for the associated event; and subtracting the generated aligner residue from the second intermediate exponent residue to provide the third intermediate exponent residue. With reference to FIGS. 9-11, an aligner residue correction may be the same for at least two events.

Next, in block 1210, an instruction dependent exponent constant is added, if required, by modulo p constant adder 519 of RPC 160, to the third intermediate exponent residue to provide a fourth intermediate exponent residue. In this case, a value of the instruction dependent constant is based on the first, second, and third operand exponents (see FIGS. 6-8). For example, an instruction dependent exponent constant may be reduced to a residue value that corresponds to a residue constant, which is added to the third intermediate exponent residue to provide the fourth intermediate exponent residue. As noted above, the residue constant may be the same for at least two instructions. Then, in block 1212, a normalizer residue is subtracted, by modulo p decrementer 520 of RPC 160, from the fourth intermediate exponent residue to generate a fifth intermediate exponent residue.

Next, in block 1214, a rounding value is added, if required, by modulo p incrementer 521 of RPC 160, to the fifth intermediate exponent residue to generate a sixth intermediate exponent residue. Then, in block 1216, an exponent wrap constant is added, if required, by modulo p corrector 522 of RPC 160 to the sixth intermediate exponent residue to generate the predicted residue. In general, the exponent wrap constant compensates for underflow or overflow. As one example, when a modulo 3 residue is employed, the exponent wrap constant residue-correction-value is zero. As noted above, blocks 1218 and 1220 execute in parallel with blocks 1204-1216. In block 1218, EXCC 150 calculates an exponent result that provides a result exponent for the floating point operation. In block 1220, residue generation circuit 524 of RPC 160 generates a result exponent residue for the result exponent.

Next, in block 1222, comparator 523 of RPC 160 compares the predicted and result exponent residues. Then, in decision block 1224, comparator 523 determines whether the predicted and result exponent residues are equal. In response to the predicted and result exponent residues being equal in block 1224, control passes to block 1228, where comparator 523 provides a ‘pass’ check indication. In response to the predicted and result exponent residues not being equal in block 1224, control passes to block 1226, where comparator 523 provides a ‘fail’ check indication. In the event an error occurs, processor 100 may log the error and cause the computation to be performed again. Following blocks 1226 and 1228, control passes to block 1230 where the process 1200 terminates until a next exponent calculation is initiated.

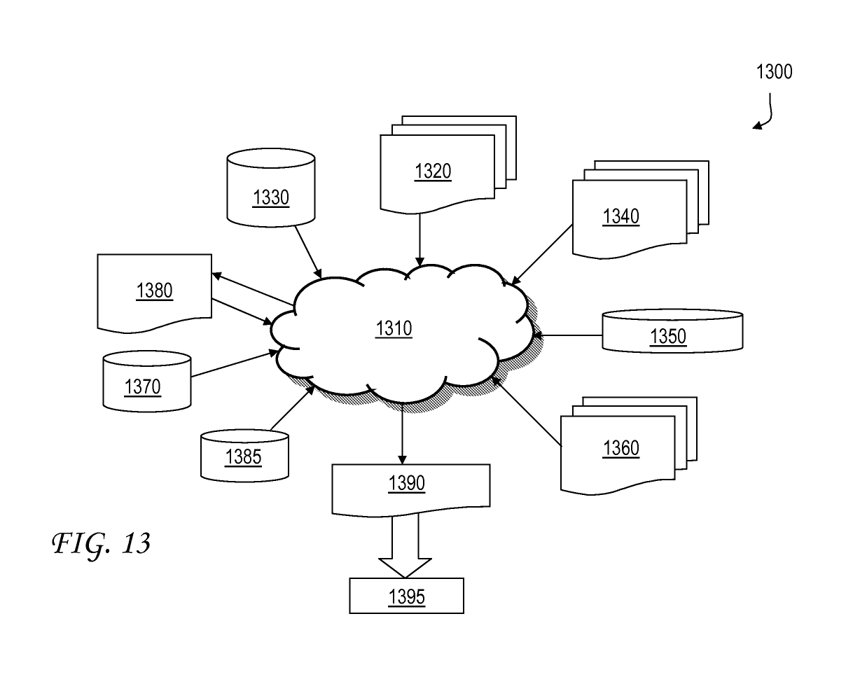

FIG. 13 shows a block diagram of an exemplary design flow 1300 used for example, in semiconductor IC logic design, simulation, test, layout, and manufacture. Design flow 1300 includes processes, machines and/or mechanisms for processing design structures or devices to generate logically or otherwise functionally equivalent representations of the design structures and/or devices described above and shown in FIGS. 5-12. The design structures processed and/or generated by design flow 1300 may be encoded on machine-readable transmission or storage media to include data and/or instructions that when executed or otherwise processed on a data processing system generate a logically, structurally, mechanically, or otherwise functionally equivalent representation of hardware components, circuits, devices, or systems. Machines include, but are not limited to, any machine used in an IC design process, such as designing, manufacturing, or simulating a circuit, component, device, or system. For example, machines may include: lithography machines, machines and/or equipment for generating masks (e.g., e-beam writers), computers or equipment for simulating design structures, any apparatus used in the manufacturing or test process, or any machines for programming functionally equivalent representations of the design structures into any medium (e.g., a machine for programming a programmable gate array).

Design flow 1300 may vary depending on the type of representation being designed. For example, a design flow 1300 for building an application specific IC (ASIC) may differ from a design flow 1300 for designing a standard component or from a design flow 1300 for instantiating the design into a programmable array, for example a programmable gate array (PGA) or a field programmable gate array (FPGA) offered by Altera® Inc. or Xilinx® Inc.

FIG. 13 illustrates multiple such design structures including an input design structure 1320 that is preferably processed by a design process 1310. Design structure 1320 may be a logical simulation design structure generated and processed by design process 1310 to produce a logically equivalent functional representation of a hardware device. Design structure 1320 may also or alternatively comprise data and/or program instructions that when processed by design process 1310, generate a functional representation of the physical structure of a hardware device. Whether representing functional and/or structural design features, design structure 1320 may be generated using electronic computer-aided design (ECAD) such as implemented by a core developer/designer. When encoded on a machine-readable data transmission, gate array, or storage medium, design structure 1320 may be accessed and processed by one or more hardware and/or software modules within design process 1310 to simulate or otherwise functionally represent an electronic component, circuit, electronic or logic module, apparatus, device, or system such as those shown in FIGS. 5-12. As such, design structure 1320 may comprise files or other data structures including human and/or machine-readable source code, compiled structures, and computer-executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher level design languages such as C or C++.

Design process 1310 preferably employs and incorporates hardware and/or software modules for synthesizing, translating, or otherwise processing a design/simulation functional equivalent of the components, circuits, devices, or logic structures shown in FIGS. 5-12 to generate a netlist 1380 which may contain design structures such as design structure 1320. Netlist 1380 may comprise, for example, compiled or otherwise processed data structures representing a list of wires, discrete components, logic gates, control circuits, I/O devices, models, etc. that describes the connections to other elements and circuits in an integrated circuit design. Netlist 1380 may be synthesized using an iterative process in which netlist 1380 is resynthesized one or more times depending on design specifications and parameters for the device. As with other design structure types described herein, netlist 1380 may be recorded on a machine-readable storage medium or programmed into a programmable gate array. The medium may be a non-volatile storage medium such as a magnetic or optical disk drive, a programmable gate array, a compact flash, or other flash memory. Additionally, or in the alternative, the medium may be a system or cache memory, or buffer space.

Design process 1310 may include hardware and software modules for processing a variety of input data structure types including netlist 1380. Such data structure types may reside, for example, within library elements 1330 and include a set of commonly used elements, circuits, and devices, including models, layouts, and symbolic representations, for a given manufacturing technology (e.g., different technology nodes, 32 nm, 45 nm, 90 nm, etc.). The data structure types may further include design specifications 1340, characterization data 1350, verification data 1360, design rules 1370, and test data files 1385 which may include input test patterns, output test results, and other testing information. Design process 1310 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 1310 without deviating from the scope and spirit of the invention. Design process 1310 may also include modules for performing standard circuit design processes such as timing analysis, verification, design rule checking, place and route operations, etc.

Design process 1310 employs and incorporates logic and physical design tools such as HDL compilers and simulation model build tools to process design structure 1320 together with some or all of the depicted supporting data structures along with any additional mechanical design or data (if applicable), to generate a second design structure 1390. Design structure 1390 resides on a storage medium or programmable gate array in a data format used for the exchange of data of mechanical devices and structures (e.g., information stored in a IGES, DXF, Parasolid XT, JT, DRG, or any other suitable format for storing or rendering such mechanical design structures). Similar to design structure 1320, design structure 1390 preferably comprises one or more files, data structures, or other computer-encoded data or instructions that reside on transmission or data storage media and that when processed by an ECAD system generate a logically or otherwise functionally equivalent form of one or more of the embodiments of the invention shown in FIGS. 5-12. In one embodiment, design structure 1390 may comprise a compiled, executable HDL simulation model that functionally simulates the devices shown in FIGS. 5-12.

Design structure 1390 may also employ a data format used for the exchange of layout data of integrated circuits and/or symbolic data format (e.g., information stored in a GDSII (GDS2), GL1, OASIS, map files, or any other suitable format for storing such design data structures). Design structure 1390 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described above and shown in FIGS. 5-12. Design structure 1390 may then proceed to a stage 1395 where, for example, design structure 1390: proceeds to tape-out, is released to manufacturing, is released to a mask house, is sent to another design house, is sent back to the customer, etc.

Accordingly, residue generation techniques for operand exponents have been disclosed herein that can be advantageously employed on execution units that support floating point operations.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” (and similar terms, such as includes, including, has, having, etc.) are open-ended when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method of checking an exponent calculation for an execution unit that supports floating point operations, comprising:
generating, using an exponent calculation circuit, a result exponent for a floating point operation;
generating, using a residue prediction circuit, a predicted exponent residue for the result exponent;
generating, using the residue prediction circuit, a result exponent residue for the result exponent; and
comparing, using the residue prediction circuit, the predicted exponent residue to the result exponent residue to determine whether the result exponent generated by the exponent calculation circuit is correct and, if not, signaling an error.

2. The method of claim 1, wherein the generating, using a residue prediction circuit, a predicted exponent residue for the result exponent further comprises:
multiplying a first operand exponent residue for a first operand exponent by a second operand exponent residue for a second operand exponent to generate a first intermediate exponent residue; and
adding a third operand exponent residue for a third operand exponent to the first intermediate exponent residue to generate a second intermediate exponent residue.

3. The method of claim 2, wherein the generating, using a residue prediction circuit, a predicted exponent residue for the result exponent further comprises:
selecting a subrange of variable bits for generation of an aligner residue for the third operand exponent based on an associated event;
generating the aligner residue based on the selected subrange of variable bits and a residue constant that is based on constant bits for the associated event; and
subtracting the generated aligner residue from the second intermediate exponent residue to provide a third intermediate exponent residue, wherein the aligner residue is the same for at least two events.

4. The method of claim 3, wherein the generating, using a residue prediction circuit, a predicted exponent residue for the result exponent further comprises:
reducing an instruction dependent exponent constant to a residue value that corresponds to a residue constant; and
adding the residue constant to the third intermediate exponent residue to provide a fourth intermediate exponent residue, wherein the residue constant for at least two instructions is the same.

5. The method of claim 4, wherein the generating, using a residue prediction circuit, a predicted exponent residue for the result exponent further comprises:
subtracting a normalizer residue from the fourth intermediate exponent residue to generate a fifth intermediate exponent residue.

6. The method of claim 5, wherein the generating, using a residue prediction circuit, a predicted exponent residue for the result exponent further comprises:
adding a rounding value to the fifth intermediate exponent residue to generate a sixth intermediate exponent residue.

7. The method of claim 6, wherein the generating, using a residue prediction circuit, a predicted exponent residue for the result exponent further comprises:
adding an exponent wrap constant to the sixth intermediate exponent residue to generate the predicted exponent residue, wherein the exponent wrap constant compensates for underflow or overflow.

8. The method of claim 1, wherein the residue prediction circuit implements modulo 3 residue calculations.

9. A residue prediction circuit for an execution unit that supports floating point operations, the residue prediction circuit comprising:
a plurality of residue generators; and
a residue checking circuit coupled to the plurality of residue generators, wherein the residue checking circuit is configured to:
generate a predicted exponent residue for a result exponent of a floating point operation, wherein the result exponent is generated by an exponent calculation circuit;
generate a result exponent residue for the result exponent; and
compare the predicted exponent residue to the result exponent residue to determine whether the result exponent generated by the exponent calculation circuit is correct and, if not, signaling an error.

10. The residue prediction circuit of claim 9, wherein the residue prediction circuit is further configured to:
multiply a first operand exponent residue for a first operand exponent by a second operand exponent residue for a second operand exponent to generate a first intermediate exponent residue; and
add a third operand exponent residue for a third operand exponent to the first intermediate exponent residue to generate a second intermediate exponent residue.

11. The residue prediction circuit of claim 10, wherein the residue prediction circuit is further configured to:
select a subrange of variable bits for generation of an aligner residue for the third operand exponent based on an associated event;
generate the aligner residue based on the selected subrange of variable bits and a residue constant that is based on constant bits for the associated event; and
subtract the generated aligner residue from the second intermediate exponent residue to provide a third intermediate exponent residue, wherein the aligner residue is the same for at least two events.

12. The residue prediction circuit of claim 11, wherein the residue prediction circuit is further configured to:
reduce an instruction dependent exponent constant to a residue value that corresponds to a residue constant; and
add the residue constant to the third intermediate exponent residue to provide a fourth intermediate exponent residue, wherein the residue constant for at least two instructions is the same.

13. The residue prediction circuit of claim 12, wherein the residue prediction circuit is further configured to:
subtract a normalizer residue from the fourth intermediate exponent residue to generate a fifth intermediate exponent residue.

14. The residue prediction circuit of claim 13, wherein the residue prediction circuit is further configured to:
add a rounding value to the fifth intermediate exponent residue to generate a sixth intermediate exponent residue.

15. The residue prediction circuit of claim 14, wherein the residue prediction circuit is further configured to:
add an exponent wrap constant to the sixth intermediate exponent residue to generate the predicted exponent residue, wherein the exponent wrap constant compensates for underflow or overflow.

16. The residue prediction circuit of claim 9, wherein the residue prediction circuit implements modulo 3 residue calculations.

17. A processor comprising:
an execution unit that supports floating point operations; and
a residue prediction circuit coupled to the execution unit, wherein the residue prediction circuit comprises:
a plurality of residue generators; and
a residue checking circuit coupled to the plurality of residue generators, wherein the residue checking circuit is configured to:
generate a predicted exponent residue for a result exponent of a floating point operation, wherein the result exponent for the floating point operation is generated by an exponent calculation circuit;
generate a result exponent residue for the result exponent; and
compare the predicted exponent residue to the result exponent residue to determine whether the result exponent generated by the exponent calculation circuit is correct and, if not, signaling an error.

18. The processor of claim 17, wherein at least some of the plurality of residue generators are located in the exponent calculation circuit.

19. The processor of claim 17, wherein at least some of the plurality of residue generators are located in the execution unit.

20. The processor of claim 17, wherein the residue prediction circuit implements modulo 3 residue calculations.

21. A design structure tangibly embodied in a machine readable medium, the design structure comprising:
an execution unit that supports floating point operations; and
a residue prediction circuit coupled to the execution unit, wherein the residue prediction circuit comprises:
a plurality of residue generators; and
a residue checking circuit coupled to the plurality of residue generators, wherein the residue checking circuit is configured to:
generate a predicted exponent residue for a result exponent of a floating point operation, wherein the result exponent for the floating point operation is generated by an exponent calculation circuit;
generate a result exponent residue for the result exponent; and
compare the predicted exponent residue to the result exponent residue to determine whether the result exponent generated by the exponent calculation circuit is correct and, if not, signaling an error.
